(19) United States
(12) Patent Application Publication
(10) Pub. No.: US 2018/0213209 A1
(43) Pub. Date: Jul. 26, 2018

(54) STEREOSCOPIC DISPLAY DEVICE

(71) Applicant: WUHAN CHINA STAR OPTOELECTRONICE TECHNOLOGY CO. LTD., Wuhan, Hubei (CN)

(72) Inventors: Hongqing CUI, Wuhan, Hubei (CN); Guowei ZHA, Wuhan, Hubei (CN)

(21) Appl. No.: 15/327,544

(22) PCT Filed: Dec. 23, 2016
(86) PCT No.: PCT/CN2016/111639

§ 371 Date: Jan. 19, 2017

(30) Foreign Application Priority Data
Nov. 29, 2016 (CN) 201611074012.4

(51) Int. Cl. H04N 13/305; G02B 27/22; G02B 27/09; G02B 27/30

(52) U.S. Cl. CPC H04N 13/0402; G02B 27/30; G02B 27/0944; G02B 27/225

(57) ABSTRACT

A stereoscopic display device is provided, which includes a display panel including a plurality of sub-pixel units; a micro lens collimating array including a plurality of collimating micro lenses configured to receive light rays from the sub-pixel units and transform the light rays into parallel light rays; and a diffraction grating array including a plurality of diffraction gratings configured to receive the parallel light rays and project the parallel light rays to a predetermined viewpoint, wherein the sub-pixel units, the collimating micro lenses, and the diffraction gratings form a one-to-one correspondence.

### TECHNICAL FIELD OF THE DISCLOSURE

The present invention relates to a display device, and more particularly, to a stereoscopic display device.

### BACKGROUND OF THE DISCLOSURE

Currently, there are two types of approaches to display a stereoscopic image for a stereoscopic display device. One is that a viewer is required to wear a pair of specially treated glasses in viewing the display device such that the images received by left and right eyes are different from each other, or the left-eye images and the right-eye images are alternatively displayed so as to generate a stereoscopic image. The other is a glassless-type display device, which primarily utilizes lens and grating technologies such that the viewer is not required to wear any additional device but the images perceived by the left and right eyes are different and thus a stereoscopic image is perceived.

However, in the existing glassless-type display device, the light rays are projected to different viewpoints after passing through different color resistant due to the dispersion property of light wavelengths, thereby resulting in rainbow stripes caused by nonuniform mixed colors.

Therefore, there is a need to provide a stereoscopic display device for solving the problems in the existing skills.

### SUMMARY OF THE DISCLOSURE

The present invention provides a stereoscopic display device for solving the technical problem of the rainbow stripes caused by nonuniform mixed colors in the existing glassless-type display device since the light rays are projected to different viewpoints after passing through different color resistant due to the dispersion property of light wavelengths.

To solve above problems, the technical schemes provided in the present invention are described below.

The present invention provides a stereoscopic display device, comprising: a display panel comprising a plurality of sub-pixel units; a micro lens collimating array comprising a plurality of collimating micro lenses configured to receive light rays from the sub-pixel units and transform the light rays into parallel light rays; and a diffraction grating array comprising a plurality of diffraction gratings configured to receive the parallel light rays and project the parallel light rays to a predetermined viewpoint, wherein the micro lens collimating array is disposed above the display panel while the diffraction grating array is disposed above the micro lens collimating array, and the sub-pixel units, the collimating micro lenses, and the diffraction gratings form a one-to-one correspondence; wherein the display panel is implemented by an organic light-emitting diode display panel, a quantum dot display panel, or a quantum dot light-emitting diode display panel; wherein the sub-pixel units are red sub-pixel units, green sub-pixel units, or blue sub-pixel units.

In the stereoscopic display device of the present invention, disposing the micro lens collimating array above the display panel is carried out by disposing an individual adhesive film of micro lens collimating array on the display panel.

In the stereoscopic display device of the present invention, disposing the micro lens array above the display panel is carried out by directly forming the micro lens collimating array on the display panel.

In the stereoscopic display device of the present invention, directly forming the micro lens collimating array on the display panel comprises: depositing a photoresist layer on the display panel; making the photoresist layer form an array with a pattern consistent with the sub-pixel units by using lithography development; heating the photoresist layer to reach a molten state and thus forming a micro lens pattern; and curing the photoresist layer to form the micro lens collimating array.

In the stereoscopic display device of the present invention, in curing the photoresist layer, the photoresist layer is cured by heating or irradiating with ultraviolet rays.

In the stereoscopic display device of the present invention, the length of a period in the diffraction grating is 200-1000 nanometer.

In the stereoscopic display device of the present invention, the duty cycle of the diffraction grating is 0.4-0.6.

In the stereoscopic display device of the present invention, the parallel light rays are projected to the predetermined viewpoint by adjusting a period and a azimuth of the diffraction grating.

The present invention further provides a stereoscopic display device, comprising: a display panel comprising a plurality of sub-pixel units; a micro lens collimating array comprising a plurality of collimating micro lenses configured to receive light rays from the sub-pixel units and transform the light rays into parallel light rays; and a diffraction grating array comprising a plurality of diffraction gratings configured to receive the parallel light rays and project the parallel light rays to a predetermined viewpoint, wherein the micro lens collimating array is disposed above the display panel while the diffraction grating array is disposed above the micro lens collimating array, and the sub-pixel units, the collimating micro lenses, and the diffraction gratings form a one-to-one correspondence.

In the stereoscopic display device of the present invention, disposing the micro lens collimating array above the display panel is carried out by disposing an individual adhesive film of micro lens collimating array on the display panel.

In the stereoscopic display device of the present invention, disposing the micro lens array above the display panel is carried out by directly forming the micro lens collimating array on the display panel.

In the stereoscopic display device of the present invention, directly forming the micro lens collimating array on the display panel comprises: depositing a photoresist layer on the display panel; making the photoresist layer form an array with a pattern consistent with the sub-pixel units by using lithography development; heating the photoresist layer to reach a molten state and thus forming a micro tens pattern; and curing the photoresist layer to form the micro lens collimating array.

In the stereoscopic display device of the present invention, in curing the photoresist layer, the photoresist layer is cured by heating or irradiating with ultraviolet rays.

In the stereoscopic display device of the present invention, the display panel is implemented by an organic light-emitting diode display panel, a quantum dot display panel, or a quantum dot light-emitting diode display panel.

In the stereoscopic display device of the present invention, the length of a period in the diffraction grating is 200-1000 nanometer.

In the stereoscopic display device of the present invention, the duty cycle of the diffraction grating is 0.4-0.6.

In the stereoscopic display device of the present invention, the sub-pixel units are red sub-pixel units, green sub-pixel units, or blue sub-pixel units.

In the stereoscopic display device of the present invention, the parallel light rays are projected to the predetermined viewpoint by adjusting a period and a azimuth of the diffraction grating.

In the stereoscopic display device of the present invention, the display panel has a micro lens collimating array and a diffraction grating array sequentially disposed thereon. After passing through the micro lens collimating array, the light rays are transformed into parallel light rays and are then incident on the diffraction grating array. By adjusting the periods and azimuths of the diffraction gratings, the parallel light rays are projected to a predetermined viewpoint, thereby avoiding the rainbow stripes caused by nonuniform mixed colors and improving the visual effects of the stereoscopic display device. In the existing glassless-type display device, the light rays are projected to different viewpoints after passing through different color resistant due to the dispersion property of light wavelengths, thereby resulting in the technical problem of the rainbow stripes caused by nonuniform mixed colors. The present invention solves such a technical problem.

### BRIEF DESCRIPTION OF THE DRAWINGS

To make the technical schemes of the present invention and the beneficial effects more clear, the present invention will be described in details using preferred embodiments in conjunction with the appending drawings.

FIG. 1 is a schematic structural diagram showing a stereoscopic display device in accordance with a preferred embodiment of the present invention.

FIG. 2 is a flow chart of formation of a micro array collimating array of a stereoscopic display device in accordance with a preferred embodiment of the present invention.

FIG. 3 is a schematic diagram showing the respective steps in forming a micro lens collimating array of a stereoscopic display device in accordance with a preferred embodiment of the present invention.

FIG. 4 is a schematic diagram showing light paths carried out in a stereoscopic display device in accordance with a preferred embodiment of the present invention.

### DETAILED DESCRIPTION OF THE DISCLOSURE

In order to further illustrate the technical scheme adopted in the present invention and the effects thereof, the preferred embodiment of the present invention is described in detail with reference to the appending drawings.

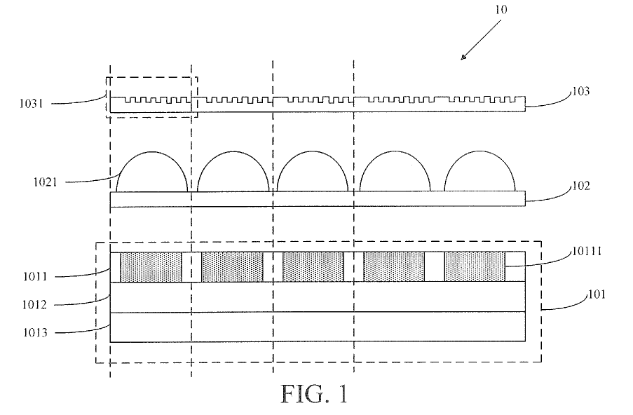

FIG. 1 is a schematic structural diagram showing a stereoscopic display device in accordance with a preferred embodiment of the present invention.

As shown in FIG. 1, the stereoscopic display device 10 of the preset preferred embodiment includes a display panel 101, a micro lens collimating array 102, and a diffraction grating array 103. The display panel 101 includes an upper glass substrate 1011, a lower glass substrate 1013, and a liquid crystal layer 1012 located between the upper glass substrate 1011 and the lower glass substrate 1013, in which the upper glass substrate 1011 has a plurality of sub-pixel units 10111 arranged thereon. In the present preferred embodiment, the display panel includes five sub-pixel units 10111. In order to avoid a complicated figure, it should be noted that the sub-pixel units 10111 of the present preferred embodiment are illustrated with five entities but the present invention is not limited thereto.

The micro lens collimating array 102 includes a plurality of collimating micro lenses 1021, which receive light rays emitted from the sub-pixel units 10111 and transform the light rays into parallel light rays. In the present preferred embodiment, the micro lens collimating array 102 includes five collimating micro lenses 1021. There exists a one-to-one correspondence between the five collimating micro lenses 1021 and the five sub-pixel units 10111 of the display panel 101. Whenever the light rays from each sub-pixel unit 10111 pass through a collimating micro lens 1021, the light rays are transformed into parallel light rays.

The diffraction grating array 103 includes a plurality of diffraction gratings 1031, which is configured to receive the parallel light rays and project the parallel light rays to a predetermined viewpoint. In the present preferred embodiment, the diffraction grating array 103 includes five diffraction gratings 1031. There exists a one-to-one correspondence between the five diffraction gratings 1031 and the five collimating micro lenses 1021. Whenever the parallel light rays corresponding to each sub-pixel unit 10111 pass through the diffraction grating 1031, the parallel light rays are projected to the predetermined viewpoint.

The micro lens collimating array 102 is disposed above the display panel 101 while the diffraction grating array 103 is disposed above the micro lens collimating array 102. Also, the sub-pixel units 10111, the collimating micro lenses 1021, and the diffraction gratings form a one-to-one correspondence.

Further in the present preferred embodiment, arranging the micro lens array 102 above the display panel 101 can be carried out by disposing an individual adhesive film of micro lens collimating array on the display panel 101. Also, in the present preferred embodiment, arranging the micro lens array 102 above the display panel 104 can be further carried out by directly forming a micro lens collimating array on the display panel 101.

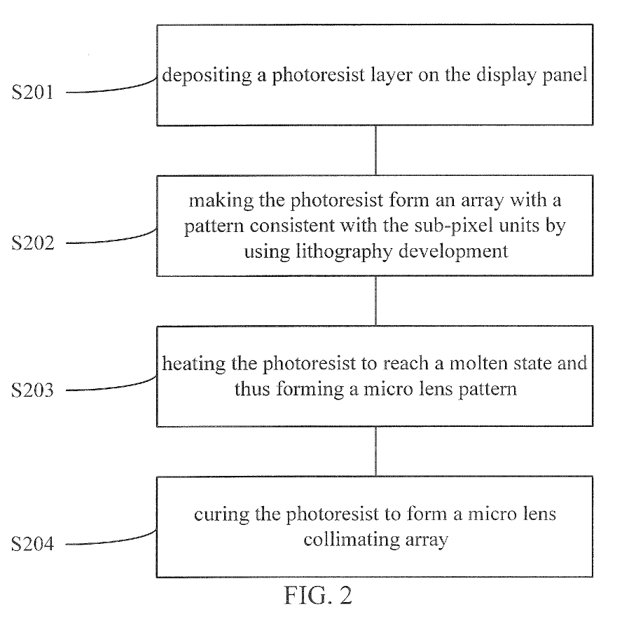

Specifically, refer to FIG. 2, which is a flow chart of formation of a micro array collimating array of a stereoscopic display device in accordance with a preferred embodiment of the present invention.

As shown in FIG. 2, directly forming the micro lens collimating array on the display panel includes the following steps.

In Step S201, depositing a photoresist layer on the display panel.

In Step S202, making the photoresist form an array with a pattern consistent with the sub-pixel units by using lithography development.

In Step S203, heating the photoresist to reach a molten state and thus forming a micro lens pattern.

In Step S204, curing the photoresist to form a micro lens collimating array.

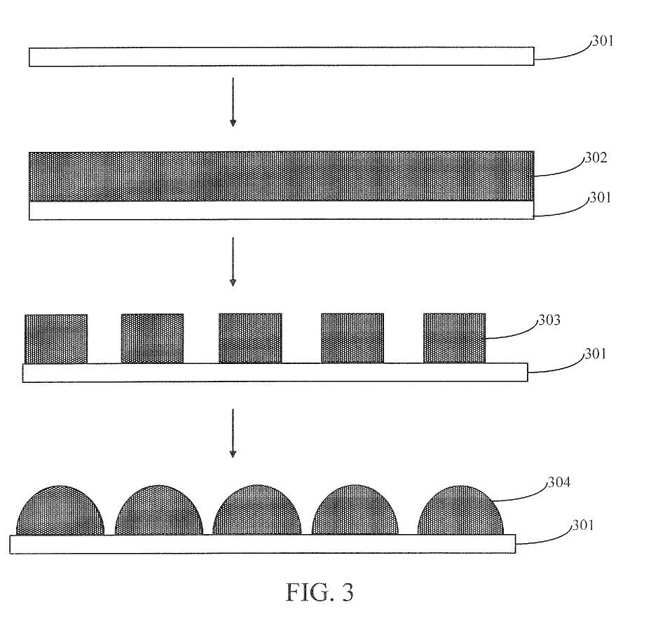

FIG. 3 is a schematic diagram showing the respective steps in forming a micro lens collimating array of a stereoscopic display device in accordance with a preferred embodiment of the present invention.

In Step S201, firstly, a display panel 301 is provided and a photoresist layer 302 is deposited on the display panel 301. Next, in Step S202, lithography development is adopted to make the photoresist 302 form an array with a pattern 303 consistent with the sub-pixel units. After that, in Step S203, the photoresist is heated to reach a molten state and thus a micro lens pattern 304 is formed. Finally, in Step S204, the photoresist is cured so as to form a micro lens collimating array. The photoresist may be cured by heating or irradiating with ultraviolet rays.

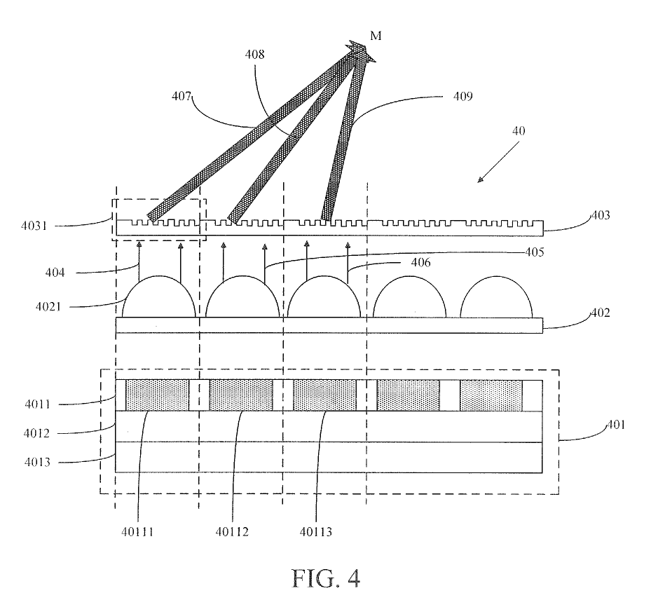

FIG. 4 is a schematic diagram showing light paths carried out in a stereoscopic display device in accordance with a preferred embodiment of the present invention.

As shown in FIG. 4, the stereoscopic display device 40 of the present preferred embodiment includes a display panel 401, a micro lens collimating array 402, and a diffraction grating array 403. The display panel 401 of the present preferred embodiment may be implemented by an organic light-emitting diode display panel, a quantum dot display panel, or a quantum dot light-emitting diode display panel. The spectral distribution carried out by the display panel 401 is characterized by narrow linewidth so as to assure that the display panel 401 has a high color gamut. When the light rays pass through the diffraction grating, the narrow linewidth property leads the light rays to have a similar angle of diffraction since the spectrum of a same color has approximately the same wavelength. The sub-pixel units of a same color are projected to approximately the same position in space, thereby ensuring that color reproduction is accurately carried out in space.

The display panel 401 includes an upper glass substrate 4011, a lower glass substrate 4013, and a liquid crystal layer 4012 located between the upper glass substrate 4011 and the lower glass substrate 4013, in which the upper glass substrate 4011 has a plurality of sub-pixel units arranged thereon. In the preset preferred embodiment, the display panel includes five sub-pixel units. Each sub-pixel unit is a red sub-pixel unit 40111, a green sub-pixel unit 40112, or a blue sub-pixel unit 40113.

The micro lens collimating array 402 includes a plurality of collimating micro lenses 4021, which receive light rays emitted from the sub-pixel units and transform the light rays into parallel light rays. In the present preferred embodiment, the micro lens collimating array includes five collimating micro lenses 4021. There exists a one-to-one correspondence between the five collimating micro lenses 4021 and the five sub-pixel units of the display panel. Whenever the light rays from each sub-pixel unit pass through a collimating micro lens, the light rays are transformed into parallel light rays.

The diffraction grating array 403 includes a plurality of diffraction gratings, which is configured to receive the parallel light rays and project the parallel light rays to a predetermined viewpoint. In the present preferred embodiment, the diffraction grating array includes five diffraction gratings 4031. There exists a one-to-one correspondence between the five diffraction gratings 4031 and the five collimating micro lenses 4021. Whenever the parallel light rays corresponding to each sub-pixel unit pass through the diffraction grating, the parallel light rays are projected to the predetermined viewpoint.

Specifically, the length of a period in the diffraction grating 4031 of the present preferred embodiment is 200-1000 nanometer and the duty cycle is 0.4-0.6.

Assuming that the length of a period in the diffraction grating 4031 is ∧, the azimuth is φ, the polar coordinate of an incident light is (0, θ), the polar coordinate of an output light is (φ₁, θ₁), the light wavelength is λ, there exists the following formula:

tan φ₁=sin φ/(cos φ−n sin θ(∧/λ))

sin² (θ₁)=(∧/λ)²+(n sin θ)²−2n sin θ cos φ(λ/┐)

Since the light rays are transformed into parallel light rays after passing through the micro lens collimating array, the polar coordinate of the incident light is (0, 0) and the polar coordinate of the output light is determined by the following formula:

tan φ₁=tan φ

sin² (θ₁)=(∧/λ)²

The present preferred embodiment can project the parallel light rays to the predetermined viewpoint by adjusting the period and azimuth of the diffraction grating. Specifically, the light rays from the red sub-pixel unit 4011 of the display panel are transformed into parallel light rays 404 after passing through a first collimating micro lens 4021 of the micro lens collimating array 402. After that, the parallel light rays 404 passing through a first diffraction grating of the diffraction grating array 402 are transformed into light rays 407 that are projected to a viewpoint M. The polar coordinate of the light rays 407 is (A1, B1), the period of the first diffraction grating is C1, the azimuth is D1, the wavelength of the parallel light rays 404 is E1, then tan A1=tan D1 and sin̂2 (B1)=(C1/E1)̂2.

The light rays from the green sub-pixel unit 4012 of the display panel are transformed into parallel light rays 405 after passing through a second collimating micro lens 4021 of the micro lens collimating array 402. After that, the parallel light rays 405 passing through a second diffraction grating of the diffraction grating array 402 are transformed into light rays 408 that are projected to the viewpoint M. The polar coordinate of the light rays 408 is (A2, B2), the period of the second diffraction grating is C2, the azimuth is D2, the wavelength of the parallel light rays 405 is E2, then tan A2=tan D2 and sin ̂2(B2)=(C2/E2)̂2.

The light rays from the blue sub-pixel unit 4013 of the display panel are transformed into parallel light rays 406 after passing through a third collimating micro lens 4021 of the micro lens collimating array 402. After that, the parallel light rays 406 passing through a third diffraction grating of the diffraction grating array 402 are transformed into light rays 409 that are projected to the viewpoint M. The polar coordinate of the light rays 409 is (A3, B3), the period of the third diffraction grating is C3, the azimuth is D3, the wavelength of the parallel light rays 406 is E3, then tan A3=tan D3 and sin ̂2(B3)=(C3/E3)̂2.

The periods and azimuths of the first diffraction grating, the second diffraction grating, and the third diffraction grating are properly controlled so as to make the light rays 407, 408, and 409 project to the viewpoint M.

In the stereoscopic display device of the present invention, the display panel has a micro lens collimating array and a diffraction grating array sequentially disposed thereon. After passing through the micro lens collimating array, the light rays are transformed into parallel light rays and are then incident on the diffraction grating array. By adjusting the periods and azimuths of the diffraction gratings, the parallel light rays are projected to a predetermined viewpoint, thereby avoiding the rainbow stripes caused by nonuniform mixed colors and improving the visual effects of the stereoscopic display device. In the existing glassless-type display device, the light rays are projected to different viewpoints after passing through different color resistant due to the dispersion property of light wavelengths, thereby resulting in the technical problem of the rainbow stripes caused by nonuniform mixed colors. The present invention solves such a technical problem.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A stereoscopic display device, comprising:
a display panel comprising a plurality of sub-pixel units;
a micro lens collimating array comprising a plurality of collimating micro lenses configured to receive light rays from the sub-pixel units and transform the light rays into parallel light rays; and
a diffraction grating array comprising a plurality of diffraction gratings configured to receive the parallel light rays and project the parallel light rays to a predetermined viewpoint,
wherein the micro lens collimating array is disposed above the display panel while the diffraction grating array is disposed above the micro lens collimating array, and the sub-pixel units, the collimating micro lenses, and the diffraction gratings form a one-to-one correspondence;
wherein the display panel is implemented by an organic light-emitting diode display panel, a quantum dot display panel, or a quantum dot light-emitting diode display panel;
wherein the sub-pixel units are red sub-pixel units, green sub-pixel units, or blue sub-pixel units.

2. The stereoscopic display device according to claim 1, wherein disposing the micro lens collimating array above the display panel is carried out by disposing an individual adhesive film of micro lens collimating array on the display panel.

3. The stereoscopic display device according to claim 1, wherein disposing the micro lens array above the display panel is carried out by directly forming the micro lens collimating array on the display panel.

4. The stereoscopic display device according to claim 3, wherein directly forming the micro lens collimating array on the display panel comprises:
depositing a photoresist layer on the display panel;
making the photoresist layer form an array with a pattern consistent with the sub-pixel units by using lithography development;
heating the photoresist layer to reach a molten state and thus forming a micro lens pattern; and
curing the photoresist layer to form the micro lens collimating array.

5. The stereoscopic display device according to claim 4, wherein in curing the photoresist layer, the photoresist layer is cured by heating or irradiating with ultraviolet rays.

6. The stereoscopic display device according to claim 1, wherein the length of a period in the diffraction grating is 200-1000 nanometer.

7. The stereoscopic display device according to claim 6, wherein the duty cycle of the diffraction grating is 0.4-0.6.

8. The stereoscopic display device according to claim 1, wherein the parallel light rays are projected to the predetermined viewpoint by adjusting a period and a azimuth of the diffraction grating.

9. A stereoscopic display device, comprising:
a display panel comprising a plurality of sub-pixel units;
a micro lens collimating array comprising a plurality of collimating micro lenses configured to receive light rays from the sub-pixel units and transform the light rays into parallel light rays; and
a diffraction grating array comprising a plurality of diffraction gratings configured to receive the parallel light rays and project the parallel light rays to a predetermined viewpoint,
wherein the micro lens collimating array is disposed above the display panel while the diffraction grating array is disposed above the micro lens collimating array, and the sub-pixel units, the collimating micro lenses, and the diffraction gratings form a one-to-one correspondence.

10. The stereoscopic display device according to claim 9, wherein disposing the micro lens collimating array above the display panel is carried out by disposing an individual adhesive film of micro lens collimating array on the display panel.

11. The stereoscopic display device according to claim 9, wherein disposing the micro lens array above the display panel is carried out by directly forming the micro lens collimating array on the display panel.

12. The stereoscopic display device according to claim 11, wherein directly forming the micro lens collimating array on the display panel comprises:
depositing a photoresist layer on the display panel;
making the photoresist layer form an array with a pattern consistent with the sub-pixel units by using lithography development;
heating the photoresist layer to reach a molten state and thus forming a micro lens pattern; and
curing the photoresist layer to form the micro lens collimating array.

13. The stereoscopic display device according to claim 12, wherein in curing the photoresist layer, the photoresist layer is cured by heating or irradiating with ultraviolet rays.

14. The stereoscopic display device according to claim 9, wherein the display panel is implemented by an organic light-emitting diode display panel, a quantum dot display panel, or a quantum dot light-emitting diode display panel.

15. The stereoscopic display device according to claim 9, wherein the length of a period in the diffraction grating is 200-1000 nanometer.

16. The stereoscopic display device according to claim 15, wherein the duty cycle of the diffraction grating is 0.4-0.6.

17. The stereoscopic display device according to claim 9, wherein the sub-pixel units are red sub-pixel units, green sub-pixel units, or blue sub-pixel units.

18. The stereoscopic display device according to claim 9, wherein the parallel light rays are projected to the predetermined viewpoint by adjusting a period and a azimuth of the diffraction grating.
